(19) United States
(12) Patent Application Publication
(10) Pub. No.: US 2008/0017828 A1
(43) Pub. Date: Jan. 24, 2008

(54) AQUEOUS COOLANTS FOR THE ENGINE RUN-IN PHASE, CONTAINING AMMONIUM SALTS OF PHTHALIC ACID MONOAMIDES

(75) Inventors: Bernd WENDEROTH, Birkenau (DE); Ladislaus Meszaros, Mutterstadt (DE); Stefan Dambach, Hassicch (DE); Hubert Rehberger, Rulzheim (DE); Christian Wulff, Mannheim (DE)

Correspondence Address: NIXON & VANDERHYE, PC, 901 NORTH GLEBE ROAD, 11TH FLOOR, ARLINGTON, VA, 22203, US

(73) Assignee: BASF Aktiengesellschaft, Ludwigshafen (DE)

(21) Appl. No.: 11/782,428

(22) Filed: Jul. 24, 2007

Related U.S. Application Data
(62) Division of application No. 10/501,549, filed on Jul. 16, 2004.

(30) Foreign Application Priority Data
Jan. 16, 2002 (DE) 10201446.9

(51) Int. Cl. C09K 5/10

(52) U.S. Cl. 252/77

(57) ABSTRACT

The present invention relates to aqueous coolants having vapor-space corrosion inhibiting properties, in particular for the run-in phase of internal combustion engines, after which the coolant is drained (engine run-in fluids), containing at least one ammonium salt of phthalic acid monoamides of the following formula (I), 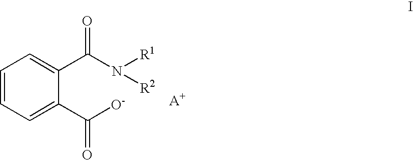
where R¹ and R² may be identical or different and are hydrogen or a linear or branched, cyclic or acyclic C₁-C₂o-alkyl radical and A⁺ is an ammonium cation.

### CROSS REFERENCE TO RELATED APPLICATIONS

This application is a divisional of commonly owned copending U.S. application Ser. No. 10/501,549, filed Jul. 16, 2004, which is the national phase application under 35 USC §371 of PCT/EP03/00422 filed Jan. 16, 2003 and claims the benefit of priority from DE 10201446.9, filed Jan. 16, 2002, the entire content thereof being hereby expressly incorporated by reference in this application.

The present invention relates to an aqueous coolant which has good vapor-space corrosion inhibitor properties as a result of the addition of ammonium salts of phthalic acid monoamides, in particular for the conservation of the engine flushing path. The novel coolants arc preferably used during the run-in phase of newly constructed engines (engine run-in fluids).

Newly constructed engines are generally subjected to short test runs after assembly. The coolants used are those based on oil or based on monoethylene glycol or monopropylene glycol. For cost reasons, it is frequently necessary to rely on the conventional coolant concentrates used in motor vehicles, which are then further diluted.

After a successful run-in phase, the coolant is then discharged and the engine is temporarily stored until final installation in the vehicle. Corrosion problems frequently occur since the engine flushing path, i.e. the cooling channels, still contain residues of coolant. Vaporization then produces an atmosphere having a high moisture content within the engine flushing path. This moisture can escape only very slowly, if at all. Such atmospheres are highly corrosion-promoting, with the result that corrosion of various degrees and in some cases of different types can often be observed during said storage of the engines.

Particularly in modern internal combustion engines, thermal loads which set high requirements with regard to the materials used are reached. Every type and any extent of corrosion constitutes a potential risk factor and can lead to reductions of the service life of the engine and to a decrease in the reliability. Furthermore, a large number of different materials, for example copper, brass, soft solder, steel, magnesium alloys and aluminum alloys, are increasingly being used in modern engines. As a result of this large number of metallic materials, potential corrosion problems additionally arise, in particular at the points where different metals are in contact with one another.

A further problem is that, when oil-based radiator antifreezes are used, the residues remaining in the flushing path are frequently immiscible with the regular coolants subsequently to be introduced. Moreover, disposal in an environmentally friendly manner is more difficult.

There is therefore a need for coolants with which effective conservation of the engine flushing path is permitted in engines after discharge of the coolant, after a successful run-in phase. A precondition for this is very good corrosion protection of the vapor space. These coolants should furthermore be compatible with the regular coolants and should be capable of being disposed of in an environmentally friendly manner.

The prior art contains references which describe vapor-space corrosion inhibitors generally.

DE 184 725 discloses the use of nitrites of alkali metals and alkaline earth metals in combination with phosphates of secondary amines in corrosion-inhibiting packaging material.

The use of sodium benzoate as a corrosion inhibitor in packaging materials is described by E. G. Stroud and W. H. J. Vernon in J. Appl. Chem. 2 (1952), 166 to 172.

DD-P 14 440 discloses a corrosion-inhibiting packaging material in which ammonium nitrites were applied together with cationic wetting agents.

DE-B 2 141 393 describes a corrosion-inhibiting packaging material which has a paper material possessing a specific fiber length; oil-soluble products from petrochemical synthesis are used as an inhibitor, preferably salts of benzoic acid.

U.S. Pat. No. 4,124,549 describes the use of salts of specific carboxylic acids, including benzoic acid, with organic amines as vapor-space corrosion inhibitors. The salts are incorporated into a thermoplastic resin which, after extrusion, is used as packaging material.

All abovementioned references disclose vapor-space corrosion inhibitors which are applied in or on packaging materials.

Other references disclose corrosion inhibitors which have a corrosion protection effect in the vapor space and can be used generally for preventing corrosion in metallic interiors.

In DD-P 298 662, this is, for example, a mixture consisting of from 2.1 to 250 g/l of ammonium benzoate, from 0.5 to 60 g/l of p-hydroxybenzoate, from 1 to 120 g/l of benzotriazole and from 0.4 to 50 g/l of dimethylaminoethanol; EP-A-221 212 proposes an aqueous mixture which acts as a vapor-space corrosion inhibitor and contains an alkylene glycol, if required a polyoxyalkylene glycol, and, as a corrosion inhibitor, a polyoxyalkyleneamine having a specific weight ratio of oxyethylene to oxypropylene.

Benzoates in combination with other substances are frequently used in mixtures for preventing corrosion in the vapor space, and the use of benzoates in cooling fluids of internal combustion engines has also long been known. These fluids are generally formulated in such a way that they are used for preventing corrosion in the liquid space.

Thus, WO 97/30133 describes corrosion-inhibiting mixtures for use as coolants in internal combustion engines, which contain quaternized imidazoles as an active ingredient. Inter alia, the sodium salts of benzoic acid may be mentioned as further components which may be present. These mixtures serve for preventing corrosion which can occur in the liquid space of the cooling channels of internal combustion engines.

Corrosion-inhibiting mixtures which are likewise used for preventing corrosion in the liquid space of the cooling channels of internal combustion engines are also disclosed in EP-A 0 816 467. The mixtures described there contain from 0.5 to 10 percent by weight of a carboxylic acid of 3 to 16 carbon atoms in the form of its alkali metal, ammonium or substituted ammonium salts and from 0.01 to 3 percent by weight of at least one hydrocarbon-triazole and/or hydrocarbon-thiazole, in particular benzotriazole and/or tolutriazole. The carboxylic acid used may be, inter alia, benzoic acid. The mixtures which are present as antifreeze concentrates are silicate-, borate- and nitrate-free.

Finally, U.S. Pat. No. 4,711,735 describes a complex mixture for preventing corrosion and deposits in cooling systems of internal combustion engines. This mixture contains from 0.017 to 0.42% of ricinoleic acid, from 0.007 to 0.083% of benzotriazole, from 0.5 to 1.5% of mercaptobenzothiazole, from 0.17 to 4% of styrenemaleic anhydride having a molecular weight of from 200 to 3500, from 0.42 to 2% of benzoic acid, from 0.42 to 4.0% of a salt of benzoic acid, from 0.33 to 3.3% of nitrite, from 0.37 to 3.7% of nitrate and from 0.42 to 3% of carboxymethylmercaptosuccinic acid. The corrosion in the liquid space is said to be prevented thereby, it also being mentioned that an effect inhibiting vapor-space corrosion can occur.

The prior art contains only a few patent applications which specifically address the prevention of vapor-space corrosion.

WO 00/22190 describes aqueous engine run-in compositions which provide protection against vapor-space corrosion and contain one or more ammonium salts of carboxylic acids which have 5 to 18, particularly preferably 6 to 12, carbon atoms.

EP A 1 111 092 describes aqueous engine run-in cooling fluids which contain ammonium and/or alkali metal salts of unsubstituted or alkyl-substituted benzoic acid as vapor-space corrosion inhibitors.

The non-prior-published German patent application of the Applicant with the application number 10064737.5 of Dec. 22, 2000 relates to aqueous coolants having vapor-space corrosion inhibiting properties for the run-in phase of internal combustion engines, containing at least one ammonium salt of an unsubstituted or substituted C₁-C₄-mono- or dicarboxylic acid.

However—as is evident from the introduction—a large number of different metals are used in the production of the various internal combustion engines. The coolants disclosed in the above-described patent applications and providing vapor-space corrosion protection offer in many cases very good or at least sufficient protection. However, this is not achieved in the case of all of the different metals used industrially to the desired extent. There is therefore still a need for coolants which permit effective vapor-space corrosion protection.

It is an object of the present invention to provide further aqueous coolants for internal combustion engines, which permit effective vapor-space corrosion inhibition in engine flushing paths from which the coolant was removed and which are then stored. In addition to an adequate corrosion inhibitor activity, these coolants should be economical, obtainable only by slight manipulation of commercial cooling fluids or coolant concentrates for internal combustion engines and be capable of being disposed of in an environmentally friendly manner.

We have found that this object is achieved by the use of ammonium salts of phthalic acid monoamides of the following formula (I) 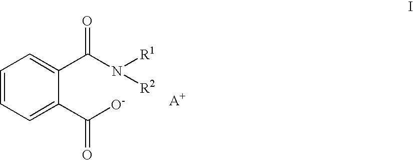
where R¹ and R² may be identical or different and are hydrogen or a linear or branched, cyclic or acyclic C₁-C₂₀-alkyl radical and A⁺ is an ammonium cation, as a vapor-space corrosion inhibitor in aqueous coolants for internal combustion engines, in particular during the run-in phase, after which the coolant is drained from the cooling circulation of the engine.

We have found that this object is furthermore achieved by an aqueous coolant having vapor-space corrosion inhibiting properties, particularly for the run-in phase of internal combustion engines, after which the coolant is drained (engine run-in fluid), containing at least one ammonium salt of phthalic acid monoamides of the formula (I) in addition to the accompanying substances and assistants customary in the case of cooling fluids for internal combustion engines.

It was found that extremely effective conservation of the engine flushing path and hence prevention of the vapor-space corrosion can be achieved by adding the ammonium salts of the above-defined phthalic acid monoamides of the formula (I) to coolants. This conservation effect occurs in particular when the coolant is drained from the cooling circulation, for example after the run-in phase, and the engine is then stored.

According to the invention, ammonium salts of a phthalic acid monoamide of the formula (I), where R¹ and R² are identical or different and have the meanings given above, are used. Examples of alkyl radicals R¹ and R² are methyl, ethyl, n-propyl, isopropyl, n-butyl, isobutyl, tert-butyl, n-pentyl, isopentyl, neopentyl, n-hexyl, cyclohexyt, n-heptyl, n-octyl, 2-ethylhexyl, isononyl, decyl, dodecyl and octadecyl.

Ammonium salts of phthalic acid monoamides of the formula (I), where R¹ and R² are identical or different and are methyl, ethyl, n-propyl, isopropyl, n-hexyl or 2-ethylhexyl and A⁺ is an ammonium cation, are preferably used.

The use of an ammonium salt of phthalic acid monoamides of the formula (I), where R¹ and R² are different from one another and are methyl and 2-ethylhexyl, is particularly preferred.

The ammonium cations A⁺ used may be cations of the type [NHR³R⁴R⁵]⁺, where R³, R⁴ and R⁵ may be identical or different and may be hydrogen or linear or branched, cyclic or acyclic alkyl radicals of 1 to 6 carbon atoms, it being possible for the alkyl radicals to be unsubstituted or substituted by one or more OH substituents.

Preferred ammonium cations A⁺ are NH₄⁺, mono-, di- and trialkylammonium cations having 1 to 5 carbon atoms per alkyl radical and mono-, di- and trialkanolammonium cations having 1 to 5 carbon atoms per alkyl radical.

NH₄⁺ and ethanolammonium cations are particularly preferred. The most preferred cation A⁺ is the triethanolammonium cation.

The most preferred salt of the formula I is the triethanolammonium salt of mono-N-methyl-N-2-ethylhexylphthalamide.

According to the invention, only a specific phthalic acid monoamide or a mixture of two or more of these stated amides, in each case in the form of the ammonium salt, can be used.

The novel salts are present in the aqueous coolant, which is introduced into the cooling channels of the engine, in concentrations of ≦10, preferably 0.1 to 5, % by weight. A particularly preferred concentration range is from 0.2 to 1.5% by weight.

The coolants used may contain the conventional accompanying substances and assistants for cooling fluids for internal combustion engines, which are known to a person skilled in the art. These are, for example, monoethylene glycol, monopropylene glycol, glycerol and/or mixtures thereof aliphatic and/or aromatic mono- and dicarboxylic acids and their alkali metal, alkaline earth metal or ammonium salts, triazole derivatives, imidazole derivatives, thiazole derivatives, silicates, nitrites, nitrates, phosphates, amines, alkali metal hydroxides, pyrrolidone derivatives, polyacrylates, alkaline earth metal salts of organic or inorganic acids, for example magnesium acetate or magnesium nitrate, molybdates, tungstates, phosphonates and borates.

The novel coolants or engine run-in fluids having a vapor-space corrosion inhibitor effect can be most simply prepared from the conventional, commercially available radiator antifreeze concentrates by appropriate addition of the phthalic acid monoamide ammonium salt of the formula (I) and subsequent dilution with water in amounts of from 1/5 to 1/20, preferably from 1/8 to 1/15, in particular 1/10, concentrate/water. These radiator antifreeze concentrates which contain ammonium salts of phthalic acid monoamides of the formula (I) also form a subject of this Application. These concentrates contain the phthalic acid monoamide ammonium salts used according to the invention in the amount correspondingly increased compared with the ready-to-use coolants, preferably from 1 to 50, in particular from 2 to 15, % by weight.

The preparation of novel engine run-in fluids by direct mixing of the individual components is also possible.

The preparation of the novel coolants—by mixing the individual components or diluting concentrates and adding the phthalic acid monoamides—is advantageously carried out at from 20 to 50° C.

The novel coolants contain water in an amount of from 80 to 98, preferably 90 to 97, percent by weight.

By simply adding the novel salts, it is possible to obtain coolants having a pronounced vapor-space corrosion inhibitor effect. Such coolants can advantageously be used in particular during the run-in phase of internal combustion engines, after the coolant is removed from the cooling circulation of the engine and the engines are temporarily stored.

The examples which follow illustrate the invention. The novel cooling fluids used were prepared by mixing the individual components, the amount of the respective substance stated in the corresponding example having been used.

### EXAMPLE

### Components For the Preparation of the Novel Aqueous Coolants A And B

| | Coolant A | Coolant B |
|---|---|---|
| Components: | % by weight | % by weight |
| Water | 94.0 | 95.5 |
| KOH, 50% strength | 1.4 | 0.9 |
| Monopropylene glycol | 0.4 | 0.4 |
| Isononanoic acid | 1.3 | 1.3 |
| Dodecane-1,12-dicarboxylic acid | 0.5 | — |
| Sodium benzoate | 0.5 | 0.5 |
| Triethanolamme | 1.2 | 0.9 |
| Mono-N-methyl-N-2-ethylhexylphthalamide, | 0.7 | 0.5 |
| triethanolammonium salt | | |

The novel aqueous coolant formulations A and B were tested in comparison with a coolant which corresponds to the composition of the coolant formulation A without the triethanolammonium salt of mono-N-methyl-N-2-ethylhexylphthalamide, in the condensation water corrosion test in a conditioned chamber according to DIN 50 017, which test is described below:

### Condensation Water Corrosion Test In A Conditioned Chamber According To DIN 50 017

The corrosion tester used was a condensation water conditioned chamber (condensation chamber) from Liebisch GmbH/Bielefeld, model KB 300/type number 430461 01.

### Test Procedure

The condensation chamber is completely cleaned before each new test, i.e. old water is completely removed, walls and ceiling are wiped with a clean cloth and the chamber is completely dried. The condensation chamber is then refilled with 4 l of distilled water.

Two boiler plates of CK 15 steel (100 mm×50 mm×3 mm) according to DIN 51357-DIN 17200 are used per test. They are thoroughly cleaned with an acetone-moistened cloth, ground on the sides and all edges by means of a grinding apparatus and thoroughly cleaned again with an acetone-moistened cloth.

The boiler plates are completely covered with the coolant to be tested in a 400 ml beaker and covered with a watch glass; thereafter, the beaker is heated until the liquid boils and is then left to cool for one hour at room temperature. The plates are then removed from the test liquid. After drying, they are suspended in the condensation chamber and the test is started. The duration of the test is 5 cycles (1 cycle 8 hours at 40° C.+16 hours at room temperature); thereafter, the test plates were removed for drying and are rated visually according to the following rating scale:

Rating Scale

| Rating | Assessment |
|---|---|
| 1 | No corrosion |
| 2 | Slight corrosion (<2% of the total area corroded) |
| 3 | Corrosion (>2% of the total area corroded) |

### Assessment of the Condensation Chamber Tests Carried Out

| Formulation tested | Rating |
|---|---|
| Coolant A | 1 |
| Coolant A without mono-N-methyl-N-2-ethylhexyl- | 2 |
| phthalamide, triethanolammonium salt | |
| Coolant B | 1 |

The results show that substantially improved corrosion protection can be achieved with novel examples in comparison with the coolant A base formulation without the triethanolammonium salt of mono-N-methyl-N-2-ethylhexylphthalamide.

1-23. (canceled)

24. An aqueous coolant having vapor-space corrosion inhibiting properties, having at least one ammonium salt of phthalic acid monoamides of the formula (I), 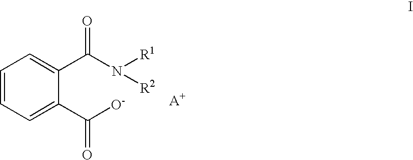
where R¹ and R² may be identical or different and are hydrogen or a linear or branched, cyclic or acyclic C₁-C₂₀-alkyl radical, and at least one accompanying substance or assistant selected from the group consisting of monoethylene glycol, monopropylene glycol, glycerol and/or mixtures thereof, aliphatic and/or aromatic mono- and dicarboxylic acids and their alkali metal, alkaline earth metal or ammonium salts, triazole derivatives, imidazole derivatives, thiazole derivatives, silicates, nitrites, nitrates, phosphates, amines, alkali metal hydroxides, pyrrolidone derivatives, polyacrylates, alkaline earth metal salts of organic or inorganic acids, preferably magnesium acetate or magnesium nitrate, molybdates, tungstates, phosphonates and borates.

25. A coolant as claimed in claim 24, wherein the ammonium salt of the phthalic acid monoamide of the formula (I) is present in an amount of 10% by weight or less in the coolant.

26. A coolant as claimed in claim 25, wherein the ammonium salt is present in an amount of from 0.1 to 5% by weight.

27. A coolant as claimed in claim 25, wherein the ammonium salt is present in an amount of from 0.2 to 1.5% by weight.

28. A coolant as claimed in claim 24, wherein ammonium salts of phthalic acid monoamides of the formula (I), where R¹ and R² are identical or different and are methyl, ethyl, n-propyl, isopropyl, n-hexyl or 2-ethylhexyl are used.

29. A coolant as claimed in claim 28, wherein R¹ und R² are methyl or 2-ethylhexyl.

30. A coolant as claimed in claim 24, wherein the ammonium ion A⁺ is a cation of the type [NHR³R⁴R⁵]⁺, where R³, R⁴ and R⁵ may be identical or different and may be hydrogen or a linear or branched, cyclic or acyclic alkyl radical of 1 to 6 carbon atoms, it being possible for the alkyl radicals to be unsubstituted or substituted by one or more OH substituents.

31. A coolant as claimed in claim 30, wherein the ammonium ion being selected from the group consisting of NH₄⁺, mono-, di- and trialkylammonium cations having 1 to 5 carbon atoms per alkyl radical and mono-, di- and trialkanolammonium cations having 1 to 5 carbon atoms per alkyl radical.

32. A coolant as claimed in claim 30, wherein A is selected from the group consisting of NH₄⁺ and ethanolammonium cations.

33. A coolant as claimed in claim 30, wherein A is the ammonium or the triethanolammonium cation.

34. A radiator antifreeze concentrate containing at least one ammonium salt of phthalic acid monoamides of the formula (I), 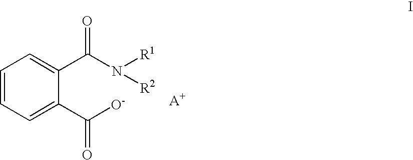
where R¹ and R² may be identical or different and are hydrogen or a linear or branched, cyclic or acyclic C₁-C₂₀-alkyl radical and A⁺ is an ammonium cation, and at least one accompanying substance or assistant selected from the group consisting of monoethylene glycol, monopropylene glycol, glycerol and/or mixtures thereof, aliphatic and/or aromatic mono- and dicarboxylic acids and their alkali metal, alkaline earth metal or ammonium salts, triazole derivatives, imidazole derivatives, thiazole derivatives, silicates, nitrites, nitrates, phosphates, amines, alkali metal hydroxides, pyrrolidone derivatives, polyacrylates, alkaline earth metal salts of organic or inorganic acids, preferably magnesium acetate or magnesium nitrate, molybdates, tungstates, phosphonates and borates.

35. A radiator antifreeze concentrate as claimed in claim 34, wherein the ammonium salt of the phthalic acid monoamide is present in an amount of from 1 to 5% by weight.

36. An antifreeze concentrate as claimed in claim 35, wherein the ammonium salt is present in as amount of from 2 to 15% by weight.

37. A radiator antifreeze concentrate as claimed in claim 34, wherein the ammonium salt of the phthalic acid monoamide of the formula (I) is the triethanolammonium salt of mono-N-methyl-N-2-ethylhexylphthalamide.
